(19) United States
(12) Patent Application Publication
(10) Pub. No.: US 2016/0061972 A1
(43) Pub. Date: Mar. 3, 2016

(54) DATA ACQUISITION APPARATUS USING ONE SINGLE LOCAL CLOCK

(71) Applicant: SERCEL, Carquefou (FR)

(72) Inventor: Jérôme LAINE, Sautron (FR)

(21) Appl. No.: 14/837,286

(22) Filed: Aug. 27, 2015

Related U.S. Application Data
(63) Continuation of application No. 14/833,227, filed on Aug. 24, 2015.

(30) Foreign Application Priority Data
Aug. 29, 2014 (EP) 14306340.2

(51) Int. Cl. G01V 1/22; G01S 19/14; G01V 1/00; G01V 1/18

(52) U.S. Cl. CPC G01V 1/223; G01V 1/18; G01S 19/14; G01V 1/003

(57) ABSTRACT

A seismic node, in a seismic data acquisition system, includes a housing having an input receiving analog seismic data and an output supplying corrected series of digital sampled and dated seismic data; a single local clock located inside the housing and configured to generate an inaccurate local clock signal (CLK); a gauging circuit configured to measure a frequency drift and a phase error of the local clock signal (CLK) based on received synchronization information; an analog-to-digital converter located inside the housing and configured to process the analog seismic signal based on the local clock signal (CLK) and to provide a series of digital sampled and dated seismic data; and a correcting circuit for generating the corrected series of digital sampled and dated seismic data based at least on the measured frequency drift and phase error of the local clock signal (CLK).

### 1. CROSS REFERENCE TO RELATED APPLICATIONS

This application is a Continuation of U.S. application Ser. No. 14/833,227, filed on Aug. 24, 2015, which claims priority and benefit from EP Application No. 14306340.3, filed on Aug. 29, 2014, the entire content of both applications being incorporated in their entirety herein by reference.

### 2. FIELD OF THE INVENTION

The field of the invention is related to seismic data acquisition systems. More specifically, the enclosed embodiments are directed to a seismic data acquisition apparatus that includes an analog-to-digital converter and a single local clock. The data acquisition apparatus forms a node of a seismic data acquisition system.

### 3. TECHNOLOGICAL BACKGROUND

There are numerous data acquisition apparatuses and methods intended to be implemented within a data acquisition system. This is the case for example in the field of seismic data acquisition system.

Typically, a seismic data acquisition system has a network with data acquisition apparatuses (or nodes) associated with seismic sensor(s) which are connected through acquisition lines to a central unit. The connection can be wired, wireless, or a mix of both. A description of such existing systems can be found, for example, in U.S. Patent Application Publication No. 2015/177399.

In one implementation, as illustrated in FIG. 3, a network 300 includes a plurality of wired acquisition lines 302. Each wired acquisition line 302 is connected to nodes (data acquisition apparatuses) 304 and concentrators 306. Thus, all seismic data can be received in the central unit 308 in a real-time manner. The nodes 304 are assembled in series along a telemetry cable and are each associated with at least one seismic sensor 310 (in general, strings of seismic sensors). These nodes process signals transmitted by the seismic sensor(s) and generate seismic data. The concentrators 306 are assembled in series along the telemetry cable and are each associated with at least one of the nodes 304. Each concentrator receives the data generated by the node(s) with which it is associated. The sensors 310 are either analog sensors or digital sensors. When analog sensors (also referred to as “geophones”) are used, they are generally interconnected by cables to form clusters referred to as “strings of geophones” 312. One or several of these strings of geophones (in series or in parallel) are connected to each node 304 (in this case, a node is also referred to as FDU, for “Field Digitizing Unit”) and this latter performs an analog to digital conversion of the signal from the groups of geophones and send these data to the central unit 308. When digital sensors are used (e.g. micro-machined accelerometers, also referred to as “MEMS-based digital accelerometer”), they are integrated in the nodes 304 (in this case, a node is also referred to as DSU, for “Digital Sensor Unit”), which eliminates the geophone strings. Each node integrates one or several digital sensors.

In a different implementation illustrated in FIG. 4, a network 400 includes wireless seismic acquisition units 402 (also referred to as RAU, for “Remote Acquisition Units”). Each wireless seismic acquisition unit 402 is independent and associated with (i.e., it is connected to or integrates one or several functions of) one or several of aforesaid nodes 304. Each wireless seismic acquisition unit 402 communicates wirelessly (directly or through one or several other wireless seismic acquisition units and/or through one or several of aforesaid concentrators) with the central unit 408 and/or with a harvesting device 420 (carried by an operator also referred to as “harvester”) if a data harvesting strategy is implemented. The set of wireless seismic acquisition units 402 could constitute a multi-hop wireless mesh network, allowing the wireless seismic acquisition units to exchange data, between them and with the central unit. Thus, each wireless seismic acquisition unit 402 stores its own data (i.e., data obtained from the node(s) 304 with which it is associated) and, eventually, also stores data received from one or several other wireless seismic acquisition units (i.e., data obtained from the node(s) associated with this or these other wireless seismic acquisition units). The sensors 310 are either analog sensors or digital sensors. When analog sensors (“geophones”) are used, each wireless seismic acquisition unit integrates, for example, one or a plurality of aforesaid nodes (as described for the first known implementation with geophones).

A classical technical problem related to such data acquisition systems—and especially to wireless data acquisition systems—is to provide all the data acquisition apparatuses (nodes) 304 with the same time reference in order to fulfill the accuracy that seismic operations require. In this regard, note that the data acquisition nodes 304 may receive seismic data recorded by sensors 310 every 2 ms. Thus, a large amount of seismic data is acquired by nodes 304 and this data needs to be as accurately as possible stamped with a time that is the same for all nodes 304.

According to one solution, each node extracts and maintains this sampling reference clock thanks to a phase-locked loop system (PLL) controlling a local oscillator. In this way, the oscillator is slaved to an external time reference that may be provided by a GNSS (Global Navigation Satellite System) receiver, for example. However, the use of a VCXO (voltage controlled crystal oscillator) controlled by a PLL has a high cost and a high energy consumption and involves strict hardware requirements for transmitting the sampling reference clock.

U.S. Pat. No. 8,260,580 proposes another solution according to which a data acquisition apparatus alleviates the above-mentioned inconvenience by making possible to obtain accurate acquisition data while minimizing energy consumption, computing load and memory load. FIG. 1 illustrates such a data acquisition apparatus 1 that includes a receiving circuit 6, for example a GPS (Global Positioning System) receiver. GPS receiver has a first local clock circuit 60, a first gauging circuit 61, and a calculation circuit 62. Data acquisition apparatus 1 also includes an analog-to-digital converter (ADC) 3, a second local clock circuit 2, a second gauging circuit 5, and a correcting circuit 4.

The analog-to-digital converter 3 samples data acquired by at least one sensor 10 (e.g., a seismic sensor), at an imperfect sampling frequency provided by the local clock circuit 2. Local clock circuit 2 generates clock signal CLK2. The correcting circuit 4 is then used to interpolate the sampled data in order to compensate for the measured frequency drift and phase error of the clock signal CLK2. The measured frequency drift and phase error are calculated/measured by the second gauging circuit 5.

The inventor has noticed that, in the solution of U.S. Pat. No. 8,260,580, two local clock circuits and two gauging circuits are used: a first local clock circuit 60 and a first gauging circuit 61, for generating a reference clock signal CLKREF at the output of the receiving circuit 6; a second local clock circuit 2, for sampling the data; and a second gauging circuit 5, for quantifying the drift of the clock signal CLK2 delivered by the second local clock circuit 2 relative to the reference clock signal CLKREF.

Thus, both the data acquisition apparatus 1 and the receiving circuit 6 use their own local clock and their own gauging circuit for measuring frequency drift and phase error of a first input clock signal in view of a second input clock signal (which can be synchronization information included in a radio communication signal). While seeking for a solution to further optimize such a data acquisition apparatus, the inventor has identified that some circuits that have the same functional goals (circuit for generating a clock signal, circuit for measuring frequency drift and phase error of a clock signal in view of another clock signal) are redundant. Thus, the existing approach is not efficient, as it leads to an increase of cost and power consumption of the data acquisition apparatus.

Therefore, there is a need to overcome these drawbacks of the existing nodes.

### 4. SUMMARY OF THE INVENTION

According to an embodiment, there is a seismic data acquisition apparatus to be used in a seismic data acquisition system for collecting seismic data. The data apparatus includes a housing housing only one local clock circuit, the local clock circuit generating a local clock signal (CLK); a gauging circuit located inside the housing and having a first input for receiving synchronization information from outside the housing and a second input for receiving the local clock signal (CLK), wherein the gauging circuit is configured to measure a frequency drift and a phase error of the local clock signal (CLK) based on the received synchronization information; an analog-to-digital converter located inside the housing and configured to receive the local clock signal (CLK) and an analog seismic signal, the analog-to-digital converter being configured to sample the analog seismic signal based on the local clock signal (CLK) and to provide a series of digital sampled and dated seismic data based on the local clock signal (CLK); and a correcting circuit connected to (i) the gauging circuit for receiving the frequency drift and the phase error of the local clock signal (CLK) and (ii) to the analog-to-digital converter for receiving the series of digital sampled and dated seismic data. The correcting circuit generates corrected series of digital sampled and dated seismic data based at least on the measured frequency drift and phase error of the local clock signal (CLK).

According to another embodiment, there is a seismic node, in a seismic data acquisition system, that includes, a housing having an input and an output; the input receiving analog seismic data from one or more seismic sensors; the output supplying corrected series of digital sampled and dated seismic data; a single local clock located inside the housing and configured to generate an inaccurate local clock signal (CLK); a gauging circuit configured to measure a frequency drift and a phase error of the local clock signal (CLK) based on received synchronization information; an analog-to-digital converter located inside the housing and configured to process the analog seismic signal based on the local clock signal (CLK) and to provide a series of digital sampled and dated seismic data; and a correcting circuit for generating the corrected series of digital sampled and dated seismic data based at least on the measured frequency drift and phase error of the local clock signal (CLK).

According to still another embodiment, there is a method for transforming an analog seismic signal into digital seismic data in a seismic node. The method includes receiving a radio communication signal including synchronization information representative of a remote reference clock signal; locally generating in a seismic node only a single clock signal (CLK); receiving analog seismic signals from at least one seismic sensor; digitizing the analog seismic signals to generate a series of digital sampled and dated seismic data based on the local clock signal (CLK); measuring a frequency drift and a phase error of the local clock signal (CLK) based on the synchronization information; and correcting the series of digital sampled and dated seismic data based at least on the measured frequency drift and phase error, to generate corrected series of digital sampled and dated seismic data.

### 5. LIST OF FIGURES

Other features and advantages of embodiments of the invention shall appear from the following description, given by way of indicative and non-exhaustive examples and from the appended drawings, of which:

FIG. 1 shows the simplified structure of a data acquisition apparatus;

FIG. 2A provides a schematic illustration of a data acquisition apparatus according to a first embodiment of the invention;

FIG. 2B provides a schematic illustration of a data acquisition apparatus according to a second embodiment of the invention;

FIG. 3 illustrates a wired seismic acquisition system; and

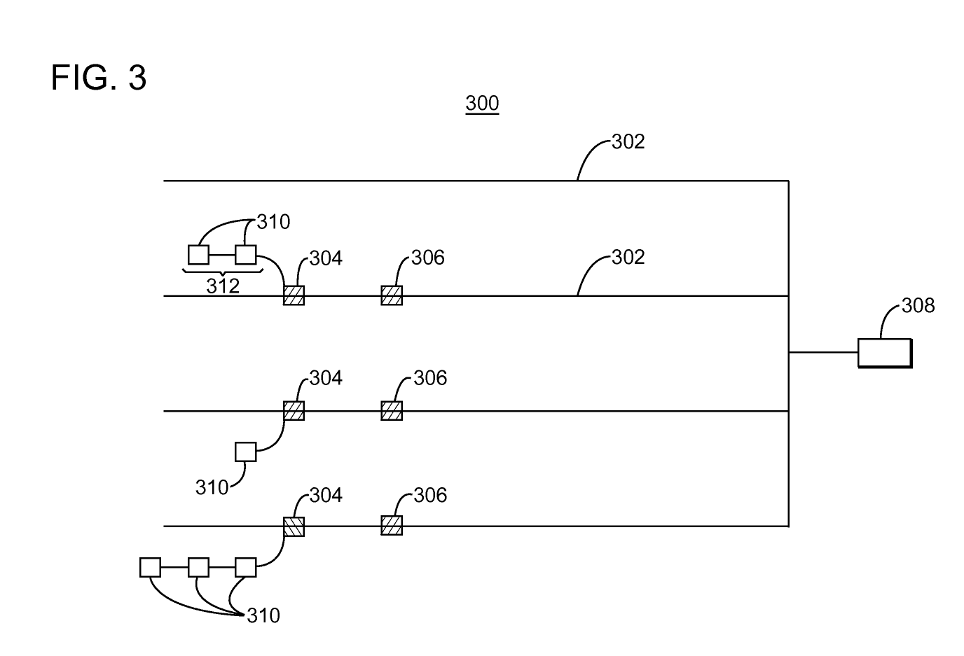

FIG. 4 illustrates a wireless seismic acquisition system.

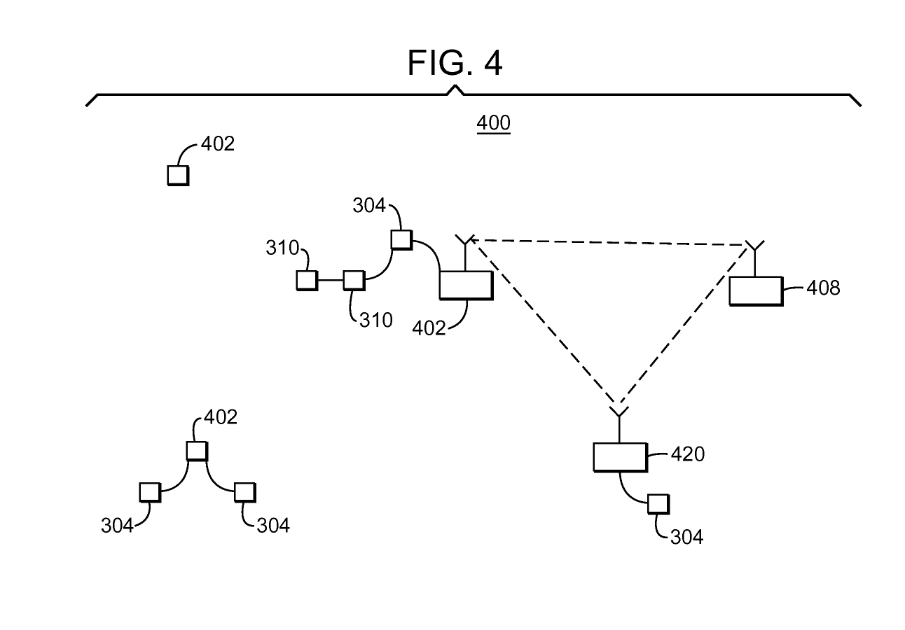

### 6. DETAILED DESCRIPTION

In all of the figures of the present document, identical elements and steps are designated by the same numerical reference sign.

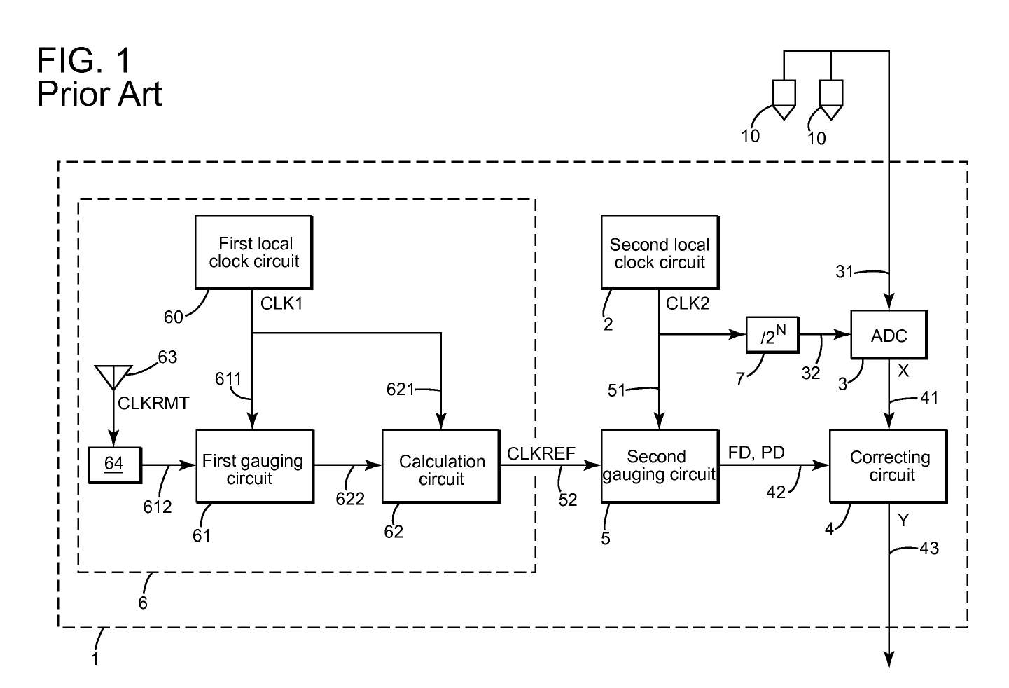

Referring now again to FIG. 1, a data acquisition apparatus 1 is dedicated to the acquisition of seismic analog data measured by at least a seismic sensor 10. Seismic analog data from sensor 10 are sent to an analog data input 31 of the analog-to-digital converter ADC 3. The apparatus 1 further includes, beside ADC 3, a local clock circuit 2 formed, for example, by a TCXO oscillator (temperature compensated crystal oscillator). The ADC 3 converts the analog seismic data received at the analog data input 31, into first digital data samples X, which is output at its output. Converter 3 has a frequency input 32 connected to the local clock circuit 2. The frequency of the digital data samples X generated by the converter 3 is set by the frequency input 32.

A frequency adapter 7 may be inserted between the local clock circuit 2 and the frequency input 32, in order to adapt the frequency of the signal CLK2 provided by the local clock circuit 2 to a desired frequency F_{E} at the frequency input 32. For example, the frequency adapter 7 may have a frequency divider to divide (e.g., by 2^{N}) a frequency F₂ of the signal provided by the local clock circuit 2 into frequency F_{E} on the frequency input 32, in case frequency F_{E} is lower than the frequency F₂. For example, the local clock circuit 2 produces a signal having a frequency F₂ of several MHz, like 8 MHz, and F_{E}=256 kHz.

The value of the local clock frequency F_{E} on input 32 is preset to cause an oversampling of the analog data at input 31 of converter 3. In one application, converter 3 may be an analog-to-digital sigma-delta converter.

The converter's output is connected to the data input 41 of a correcting circuit 4. The correcting circuit 4 may be, for example, an interpolation filter. The correcting circuit 4 contains a module for producing data Y at an interpolation output 43, where data Y has the sampling frequency F_{E}. Data Y at interpolation output 43 is calculated based on an interpolation function F, which takes into account the first one bit of data samples X at data input 41. In the correcting circuit 4, the interpolation function F is calculated for each of the second data Y by a computation module that uses the frequency drift FD and the phase error PD of the clock signal CLK2, which is provided by the local clock circuit 2. The interpolation function F has a preset fixed degree. In one application, the correcting circuit 4 may be embodied by a finite impulse response (FIR) filter.

The frequency drift FD and phase error PD are calculated by a gauging module 5 that has a first frequency input 51 connected to the local clock circuit 2 for receiving the imperfect periodic clock signal CLK2, supplied by the local clock circuit 2 and having frequency F₂, and a second frequency input 52 connected to a reference clock output of a receiving circuit 6 for receiving a periodic reference clock signal CLKREF. In order to optimize costs, this receiving circuit 6 is usually a mass-produced off-the-shelf component, not specifically dedicated to seismic data acquisition field. For example, the receiving circuit 6 supplying a reference clock signal is a satellite-based positioning system, such as a GPS receiver, or a simple RF receiver circuit. The periodic clock signal is represented by pulses or fronts or another signal pattern, called generally, periodic time pattern repeating at frequency F₂ and able to be detected. The periodic reference clock signal CLKREF is represented by pulses or fronts or another signal pattern, or square signals called generally, periodic time pattern repeating at a frequency F_{REF}, which may be equal to or different from frequency F₂ and which is also able to be detected. The receiving circuit 6 is used as a synchronization source supplying time-stamped signal, which are pulses.

An embodiment of the gauging circuit 5 calculating the frequency drift FD and phase error PD of the imperfect periodic clock signal CLK2 is described hereunder. The receiving circuit 6 supplies a reference frequency F_{REF}. The gauging circuit 5 measures frequency F₂ based on reference frequency F_{REF}. For example, in order to measure F₂, the number NF of periods of F₂ during the time interval defined by a number NFREF of periods of F_{REF} is counted by a counter. Then F₂ is obtained by using expression: F₂=F_{REF}·NF/NFREF.

Then, the frequency drift FD is obtained based on the measured frequency F₂ by:

FD=(F₂−F_{2-SET})/F_{2-SET}.

wherein F_{2-SET} is a fixed and stored setting value of frequency for F₂.

FD represents the measured frequency error of the clock signal delivered by the local clock circuit 2. FD is expressed as a percentage value of actual TCXO frequency compared to a typical value. The frequency drift FD is expressed in parts per million (ppm).

The gauging circuit 5 comprises also a module for measuring a phase shift representative of the phase error PD of the sampling signal sent to the analog-to-digital converter input 32 with respect to the reference clock signal CLKREF. Correcting circuit 4 is configured to compensate the frequency drift FD and the phase error PD.

Once the gauging circuit 5 has performed a gauging of the frequency drift FD and phase error PD of the local clock signal, the receiving circuit 6 may be turned off for the duration of the gauging's validity by using appropriate software and/or hardware implementations that are known in the art. This action makes possible to save energy.

Data Y produced at the interpolation output 43 of the correcting circuit 4 may finally be sent to a decimation filter (not represented on FIG. 1), to produce final corrected digital data.

An embodiment of the receiving circuit 6 is described hereunder. A classical technique to obtain the reference clock signal CLKREF in a wireless system is to measure the frequency drift and phase error of a local clock signal CLK1 in view of synchronization information representative of a remote reference clock signal CLKRMT, which is included in a radio communication signal received by a RF receiver 64. This local clock signal, which is delivered by a local clock circuit formed, for example, by a TCXO oscillator, is then synchronized, based on the measured frequency drift and phase error, resulting in the generation of the reference clock signal. The local clock circuit can be part or not of the receiving circuit.

In some embodiments, the receiving circuit 6 is thus able to receive, by means of a receiving antenna 63, a radio communication signal CLKRMT including synchronization information representative of a remote reference clock signal. The receiving circuit 6 includes a local clock circuit 60, a gauging circuit 61 for measuring the frequency drift and phase error of the local clock signal CLK1 delivered by the local clock circuit 60 in view of the synchronization information, and a calculation circuit 62, able to synchronize the local clock signal CLK1 based on the frequency drift and phase error. The gauging circuit 61 has a first frequency input 611 connected to the local clock circuit 60 for receiving the first imperfect periodic clock signal CLK1 supplied by the local clock circuit 60, and a second frequency input 612 for receiving the synchronization information representative of the remote reference clock signal CLKRMT. Frequency drift and phase error calculated at the gauging circuit 61 are sent to a first input 622 of the calculation circuit 62, while the imperfect periodic clock signal CLK1 supplied by the local clock circuit 60 is also sent to the second input 621 of the calculation circuit 62. The calculation circuit 62 synchronizes the imperfect periodic clock signal CLK1 supplied by the local clock circuit 60, based on the measured frequency drift and phase error, thus providing a reference clock signal CLKREF at its output, which is also an output of the receiving circuit 6. However, as discussed above, this apparatus uses redundant local clocks and gauge circuits.

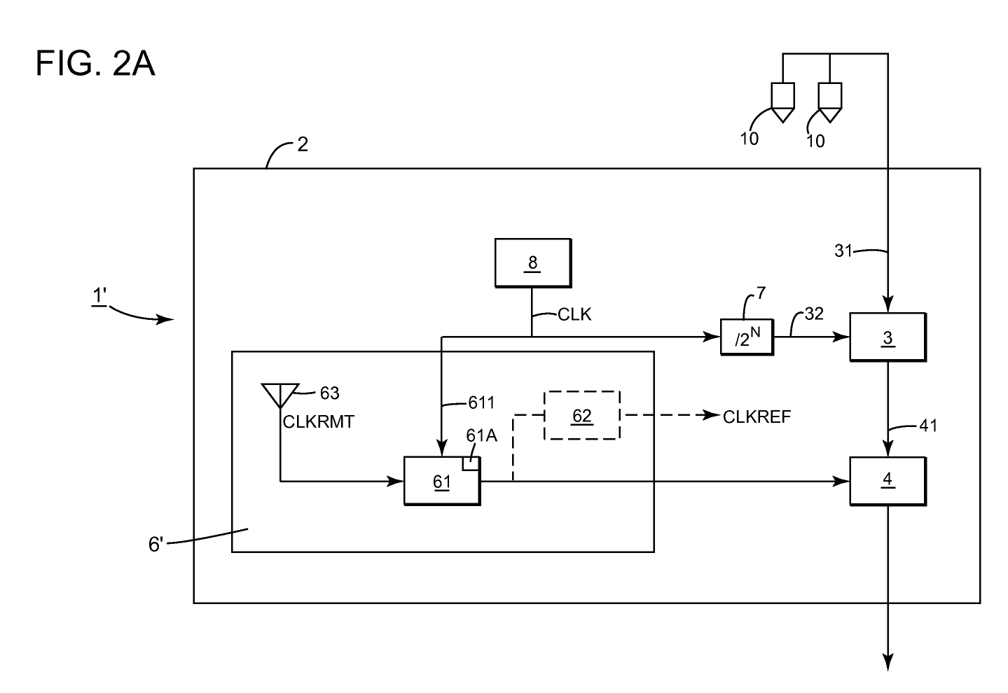

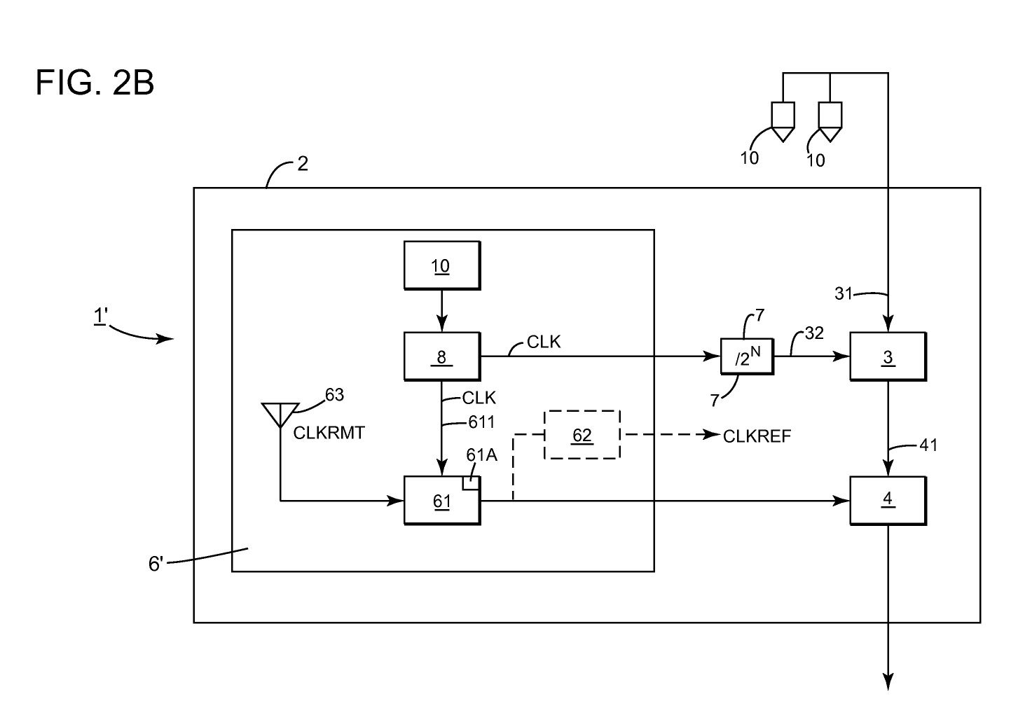

Referring now to FIG. 2A, a novel data acquisition apparatus is presented that has a reduced number of local clocks and gauging circuits compared to the existing seismic nodes. This data acquisition apparatus incorporates some of the principles of operation previously described in FIG. 1, in particular, using a correcting circuit to correct data sampled at an imperfect frequency delivered by a local clock circuit, based on the frequency drift and phase error of the local clock signal measured by a gauging circuit in view of a reference clock signal. However, while the traditional data acquisition apparatus needs at least two local clock circuits and two gauging circuits, the novel data acquisition apparatus described hereunder needs only one local clock circuit and one gauging circuit.

As presented in greater detail here below, the novel data acquisition apparatus 1′ is dedicated to the acquisition of analog data measured by at least a sensor 10. Data may be seismic data, or another type. Examples of analog sensors are geophones, translation sensors, velocimeters, accelerometers, pressure sensors. Unlike the aforesaid known solution of FIG. 1, the data acquisition apparatus 1′, according to the proposed solution, needs only one local clock circuit and one gauging circuit. The use of a single local clock circuit is made possible by the fact that the receiving circuit 6′ has a module, for example, a sigma-delta fractional PLL (Phase-Locked Loop), for adapting any clock signal frequency (or at least a wide range of frequencies) applied to its clock signal input to its desired operating frequency. Examples of the receiving circuit 6′ are an RF receiver or a GNSS receiver (e.g., GPS receiver).

According to this embodiment, a gauging circuit input 611 and a converter input 32 are now connected to a same single local clock circuit 8, instead of using the two local clock circuits 2 and 60 in FIG. 1. Cost and power consumption are thus reduced compared to the solution of FIG. 1.

The local clock circuit 8 is formed, for example, by a local oscillator such as a simple crystal oscillator, a TCXO oscillator (temperature compensated crystal oscillator) or a OCXO oscillator (oven-controlled crystal oscillator). The receiving circuit 6′ includes its own gauging circuit 61, which delivers frequency drift and phase error of the local clock signal CLK in view of the synchronization information included in the radio communication signal CLKRMT received through the receiving antenna 63. The frequency drift and phase error information is sent directly to the correcting circuit 4, to be used to correct the series of the digital sampled and dated data X.

In other words, there is no need for the second gauging circuit 5 for measuring a frequency drift and a phase error of the local clock signal in view of a reference clock signal, since this functionality is already achieved by the gauging circuit 61 of the receiving circuit 6′, and the synchronization information CLKRMT included in the radio communication signal, which is used as being the reference clock. That means that the calculation circuit 62 of the receiving circuit 6′ is not used anymore for the scope of the data acquisition apparatus according to this particular embodiment. All these elements are located in a housing 2.

As already described in the apparatus of FIG. 1, a frequency adapter 7 may be inserted between the local clock circuit 8 and the frequency input 32, in order to adapt the frequency of the signal CLK provided by the local clock circuit 8 to the desired frequency F_{E} at the frequency input 32 of the converter 3. In other embodiments of this invention, the frequency adapter 7 may be inserted upstream, immediately at the local clock circuit output, in order to adapt the frequency of the signal CLK provided by the local clock circuit 8 to the same desired frequency on the frequency inputs 611 and 32.

The embodiment presented in FIG. 2A shows a local clock circuit 8, which is external to the receiving circuit 6′. The data acquisition apparatus 1′ may include a switching circuit 61A for turning off at least partially the receiving circuit 6′, once the gauging circuit 61 has performed a gauging of the frequency drift FD and phase error PD of the local clock signal CLK. The receiving circuit 6′ then remains turned off for the duration of the validity of the gauging, thus making it possible to save energy. Before the gauging validity's duration has elapsed, the receiving circuit 6′ is turned on and the gauging circuit 61 can then perform a new gauging.

It is noted that because only local clock 8 is present in data acquisition apparatus 1′, antenna 63 provides synchronization information to gauging circuit 61, and gauging circuit 61 now calculates the frequency drift and the phase error, which are supplied to correcting circuit 4. Further, because of the presence of only one local clock inside the apparatus, the local clock 8 provides its signal to converter 3 and gauging circuit 61 and correcting circuit 4 is connected to receive information from both converter 3 and gauging circuit 61. The signal transmissions between the local clock 8, converter 3, gauging circuit 61, and correcting circuit 4 are shows in FIGS. 2A and 2B as being made in a wired manner, e.g., through copper connections.

All these modifications of the data acquisition apparatus 1′ make it cheaper, lighter, and less energy consuming, which is desired for seismic data acquisition systems.

In an alternative implementation illustrated in FIG. 2B, the local clock circuit 8 is internal to the receiving circuit 6′, but has its own power supply circuit 10. Therefore, it is still possible for the data acquisition apparatus 1′ to turn off at least partially the receiving circuit 6′ without turning off the local clock circuit 8.

In the embodiments described in FIGS. 2A-B, the receiving circuit 6′ is thus cleverly used for other purpose than its primary function. While a person skilled in the art would only use such a mass-produced, off-the-shelf component, for its well-known ability to provide a reference clock signal, the inventor had the idea of modifying this component from its intended use, i.e., using it as a gauging circuit, by collecting internal data (frequency drift and phase error of the local clock signal).

This new approach has several advantages: since there is no use anymore for a specific second gauging circuit for measuring a second frequency drift and a second phase error of the local clock signal—the gauging circuit 61 already available in the receiver circuit 6′ being used—cost and power consumption are reduced. Moreover, higher accuracy is obtained since the local clock frequency and phase calibration is done directly in view of the synchronization information included in the radio communication signal CLKRMT being received, instead of being done in view of a reference clock generated from a previous local clock frequency and phase calibration.

According to the embodiments described in FIGS. 2A-B, the receiving circuit 6′ may still include a calculation circuit 62, even if this calculation circuit does not participate in implementing the technique proposed to obtain accurate acquisition data while minimizing energy consumption, computing load and memory load. This means that the reference clock CLKREF calculated by the calculation circuit 62 remains available if required to perform any other function within the data acquisition apparatus. According to an alternative embodiment, the receiving circuit does not include the calculation circuit 62 anymore. In one embodiment, the receiving circuit 6′ is reduced to the minimum necessary to implement the previously described technique. If this is the case, the receiving circuit 6′ is then not necessary an off-the-shelf component anymore. It can be reduced to a simple combination of a receiving antenna—receiving a radio communication signal including synchronization information representative of a remote reference clock signal—in association with a gauging circuit, for measuring a frequency drift and a phase error of a local clock signal in view of this synchronization information.

According to another embodiment, the receiving antenna 63 and the gauging circuit 61 are not encapsulated in a receiving circuit 6 anymore.

According to an embodiment, there is a data acquisition apparatus that includes:

a receiving antenna, receiving a radio communication signal including synchronization information representative of a remote reference clock signal;

a local clock circuit, delivering a local clock signal (CLK);

a gauging circuit, measuring a frequency drift and a phase error of said local clock signal (CLK) in view of said synchronization information;

an analog-to-digital converter, providing a series of digital sampled and dated data according to said local clock signal (CLK); and

a correcting circuit, correcting the series of digital sampled and dated data based at least on the measured frequency drift and phase error.

This apparatus uses:

a single local clock signal (CLK) as input for both the gauging circuit and the analog-to-digital converter; and

the frequency drift and phase error of the local clock signal (CLK) in view of the synchronization information, as input for the correcting circuit.

In other words, the data acquisition apparatus of this embodiment does not generate a reference clock signal (CLKREF), but directly uses the frequency drift and phase error of the local clock signal (CLK) in view of the synchronization information, as input for the correcting circuit.

Thus, this implementation optimizes power consumption and cost of the data acquisition apparatus (compared to the aforesaid known solution of FIG. 1), since only one local clock circuit is used instead of two as in FIG. 1 and only one gauging circuit is used instead of two as in FIG. 1.

Moreover, higher data accuracy is obtained because the local clock frequency and phase calibration is done directly based of the synchronization information included in the radio communication signal received, instead of being done in view of a “local” reference clock being itself generated from a previous local clock frequency and phase calibration.

According to an embodiment, the receiving antenna and the gauging circuit are part of a receiving circuit. Thus, the proposed solution of this embodiment is easy to implement since it is possible to use an existing and cheap receiving circuit.

According to another embodiment, the receiving circuit is a RF receiver. In another embodiment, the receiving circuit is a GNSS receiver. Thus, the synchronization information included in the radio communication received is reliable, and data accuracy is optimized.

According to still another embodiment, the local clock circuit is external to the receiving circuit, and the data acquisition apparatus includes a switching circuit for turning off at least partially the receiving circuit once the gauging circuit has measured the frequency drift and phase error. Thus, the receiving circuit may be turned off for the duration of validity of the gauging, in order to minimize power consumption of the data acquisition apparatus.

In another embodiment, the local clock circuit is internal to the receiving circuit, and the data acquisition apparatus includes a circuit for turning off, at least partially, the receiving circuit without turning off the local clock circuit once the gauging circuit has measured the frequency drift and said phase error.

Thus, the receiving circuit may be partially turned off for the duration while the gauging is valid, in order to minimize power consumption of the data acquisition apparatus.

According to another embodiment, the data acquisition apparatus is a seismic data acquisition unit. In another embodiment, the invention pertains to a data acquisition method carried out by the above-mentioned data acquisition apparatus, and comprising the following steps:

a) receiving a radio communication signal including synchronization information representative of a remote reference clock signal;

b) delivering a local clock signal (CLK);

c) measuring a frequency drift and a phase error of said local clock signal (CLK) in view of said synchronization information;

d) providing a series of digital sampled and dated data according to said local clock signal (CLK); and

e) correcting the series of digital sampled and dated data based at least on the measured frequency drift and phase error.

According to a particular feature, the data acquisition method further comprises a step f) of turning off at least partially a receiving circuit, which carries out said steps a) and c), once step c) has been carried out.

In another embodiment, step f) is carried out without turning off a local clock circuit, which is internal to the receiving circuit and generates the local clock signal (CLK).

1. A seismic data acquisition apparatus to be used in a seismic data acquisition system for collecting seismic data, the data apparatus comprising:
a housing housing only one local clock circuit, the local clock circuit generating a local clock signal (CLK);
a gauging circuit located inside the housing and having a first input for receiving synchronization information from outside the housing and a second input for receiving the local clock signal (CLK), wherein the gauging circuit is configured to measure a frequency drift and a phase error of the local clock signal (CLK) based on the received synchronization information;
an analog-to-digital converter located inside the housing and configured to receive the local clock signal (CLK) and an analog seismic signal, the analog-to-digital converter being configured to sample the analog seismic signal based on the local clock signal (CLK) and to provide a series of digital sampled and dated seismic data based on the local clock signal (CLK); and
a correcting circuit connected to (i) the gauging circuit for receiving the frequency drift and the phase error of the local clock signal (CLK) and (ii) to the analog-to-digital converter for receiving the series of digital sampled and dated seismic data,
wherein the correcting circuit generates corrected series of digital sampled and dated seismic data based at least on the measured frequency drift and phase error of the local clock signal (CLK).

2. The apparatus of claim 1, further comprising:
a receiving antenna connected to the gauging circuit, the receiving antenna receiving in a wireless manner the synchronization information.

3. The apparatus of claim 2, wherein the synchronization information is representative of a remote reference clock signal.

4. The apparatus of claim 3, wherein the remote reference clock signal is included in a radio communication signal.

5. The apparatus of claim 2, further comprising:
a receiving circuit that includes the gauging circuit.

6. The apparatus of claim 5, wherein the receiving circuit is a radio-frequency (RF) receiver.

7. The apparatus of claim 5, wherein the receiving circuit is a global navigation satellite system (GNSS) receiver.

8. The apparatus of claim 5, wherein the local clock circuit is external to the receiving circuit.

9. The apparatus of claim 5, further comprising:
a switching circuit for turning off, at least partially, the receiving circuit once the gauging circuit has measured the frequency drift and the phase error.

10. The apparatus of claim 5, wherein the local clock circuit is internal to the receiving circuit, and the data acquisition apparatus comprises a switching circuit for turning off, at least partially, the receiving circuit without turning off the local clock circuit once the gauging circuit has measured the frequency drift and the phase error.

11. The apparatus of claim 1, wherein the analog-to-digital converter converts the analog seismic signal into digital data.

12. The apparatus of claim 1, further comprising:
seismic sensors located outside the housing,
wherein the seismic sensors record the analog seismic signal.

13. The apparatus of claim 1, further comprising:
a calculation circuit connected to the gauging circuit and configured to generate a reference signal (CLKREF).

14. A seismic node in a seismic data acquisition system, the seismic node comprising:
a housing having an input and an output;
the input receiving analog seismic data from one or more seismic sensors;
the output supplying corrected series of digital sampled and dated seismic data;
a single local clock located inside the housing and configured to generate an inaccurate local clock signal (CLK);
a gauging circuit configured to measure a frequency drift and a phase error of the local clock signal (CLK) based on received synchronization information;
an analog-to-digital converter located inside the housing and configured to process the analog seismic signal based on the local clock signal (CLK) and to provide a series of digital sampled and dated seismic data; and
a correcting circuit for generating the corrected series of digital sampled and dated seismic data based at least on the measured frequency drift and phase error of the local clock signal (CLK).

15. The node of claim 14, further comprising:
a receiving antenna connected to the gauging circuit, the receiving antenna receiving in a wireless manner the synchronization information from a remote reference clock signal.

16. The node of claim 14, further comprising:
a switching circuit for turning off the gauging circuit.

17. A method for transforming an analog seismic signal into digital seismic data in a seismic node, the method comprising:
receiving a radio communication signal including synchronization information representative of a remote reference clock signal;
locally generating in a seismic node only a single clock signal (CLK);
receiving analog seismic signals from at least one seismic sensor;
digitizing the analog seismic signals to generate a series of digital sampled and dated seismic data based on the local clock signal (CLK);
measuring a frequency drift and a phase error of the local clock signal (CLK) based on the synchronization information; and
correcting the series of digital sampled and dated seismic data based at least on the measured frequency drift and phase error, to generate corrected series of digital sampled and dated seismic data.

18. The method of claim 17, wherein the step of measuring is suspended from time to time while the step of correcting is performed continuously.

19. The method of claim 17, wherein the step of receiving a radio communication signal is suspended from time to time while the step of correcting is performed continuously.

20. The method of claim 17, wherein the step of locally generating only a single clock signal (CLK) is simultaneously suspended with the step of measuring or the step of receiving a radio communication signal.
